(19) United States
(12) Patent Application Publication
(10) Pub. No.: US 2024/0011308 A1
(43) Pub. Date: Jan. 11, 2024

(54) ENGINEERING MACHINERY

(71) Applicant: SANY AUTOMOBILE MANUFACTURING CO., LTD., Changsha (CN)

(72) Inventors: Shihui XIE, Changsha (CN); Tianming CHEN, Changsha (CN); Jiangbo LI, Changsha (CN)

(73) Assignee: SANY AUTOMOBILE MANUFACTURING CO., LTD., Changsha (CN)

(21) Appl. No.: 18/472,587

(22) Filed: Sep. 22, 2023

Related U.S. Application Data
(63) Continuation of application No. PCT/CN2021/103198, filed on Jun. 29, 2021.

(30) Foreign Application Priority Data
Mar. 31, 2021 (CN) 202110353630.7

(51) Int. Cl. E04G 21/04

(52) U.S. Cl. CPC E04G 21/0436

(57) ABSTRACT

An engineering machinery includes a cab, a vehicle body located behind the cab, a rotating platform provided on the vehicle body, and multiple-sectional booms articulated in sequence, wherein a centerline of gyration of the rotating platform is located in a middle of the vehicle body, a first sectional boom is articulated with the rotating platform, and the first sectional boom extends from the rotating platform toward a rear end of the vehicle body, a second sectional boom is articulated with the first sectional boom and folded above the first sectional boom, the first sectional boom to a fourth sectional boom are folded into an R shape, a projection of a third sectional boom at least partially overlaps a projection of the cab on a vertical projection plane perpendicular to a length direction of the vehicle body.

### CROSS-REFERENCE TO RELATED APPLICATIONS

This application is a continuation application of International Application No. PCT/CN2021/103198, filed on Jun. 29, 2021, which claims priority to Chinese Patent Application No. 202110353630.7, filed on Mar. 31, 2021. The disclosures of the above-mentioned applications are incorporated herein by reference in their entireties.

### TECHNICAL FIELD

The present application relates to the field of mechanical technology, specifically, relates to an engineering machinery.

### BACKGROUND

A concrete pump truck has a rotating platform and a boom device provided on the rotating platform. The boom device includes multiple-sectional booms. Driven by the driving device, the multiple-sectional booms can be expanded, collapsed, rotated, folded and so on. A delivery pipe is fixed on the boom device, and the delivery pipe moves with the boom device, so that concrete can be delivered to designated locations. When the concrete pump truck is not in working condition, the multiple-sectional booms are folded to minimize the space occupied by the concrete pump truck.

When the boom device is in a folded state, it is constrained in the height direction, resulting in small layout space in the vertical direction. Therefore, making full use of the space in the vertical direction to fold the boom device compactly is very critical to increasing the overall length of the boom device and improving the flexibility of the boom device in layouting materials. At present, the folding methods of the boom device of the concrete pump truck mainly include R-shaped folding method, Z-shaped folding method, RZ-shaped folding method and so on. The R-shaped folding method is that the multiple-sectional booms are folded in one direction, such as clockwise, and unfolded in the opposite direction, such as counterclockwise, in a rolling or intervolving manner. The Z-shaped folding method is that the multiple-sectional booms fold or unfold in opposite directions in sequence. The RZ-shaped is a combination of R-shaped and Z-shaped.

When the boom device of the pump truck in the prior art needs to be constructed toward the front of the pump truck, the boom device needs to be rotated 180°, which affects the construction efficiency.

### SUMMARY

The present application aims to solve at least one of the technical problems existing in the prior art or related art.

To this end, the purpose of the present application is to overcome the shortcomings of low construction efficiency of engineering machinery boom devices in the prior art, thereby providing an engineering machinery that can improve construction efficiency.

In order to achieve the above purpose, the technical solution of the present application provides an engineering machinery, including a cab, a vehicle body located behind the cab, a rotating platform provided on the vehicle body and multiple-sectional booms articulated in sequence; wherein a centerline of gyration of the rotating platform is located in a middle of the vehicle body, a first sectional boom is articulated with the rotating platform, and the first sectional boom extends from the rotating platform toward a rear end of the vehicle body, a second sectional boom is articulated with the first sectional boom and folded above the first sectional boom, the first sectional boom to a fourth sectional boom are folded into an R shape, a projection of a third sectional boom at least partially overlaps a projection of the cab on a vertical projection plane perpendicular to a length direction of the vehicle body.

Optionally, one end of the fourth sectional boom extends above the cab, or the cab is located between two ends of the fourth sectional boom.

Optionally, the multiple-sectional booms include at least five-sectional booms, a fifth sectional boom is articulated with the fourth sectional boom and is located above or below the fourth sectional boom, a hinge point of the fifth sectional boom and the fourth sectional boom is located above the cab, or a hinge point of the fifth sectional boom and the fourth sectional boom is located in the front of the cab.

Optionally, a height of projection overlap between the third sectional boom and the cab on a vertical projection plane is greater than/of a height of the third sectional boom.

Optionally, the first sectional boom is inverted.

Optionally, the third sectional boom is a bending boom including a first straight arm section, a bending section and a second straight arm section, the bending section avoids the rotating platform; the first straight arm section is articulated with the second sectional boom and folded below the second sectional boom; the fourth sectional boom is articulated with the second straight arm section and folded above the second straight arm section.

Optionally, a hinge point of the second sectional boom and the third sectional boom is located between the cab and the rotating platform, or a hinge point of the second sectional boom and the third sectional boom is located above a rear of the cab.

Optionally, the multiple-sectional booms include at least six-sectional booms, a sixth sectional boom is articulated with a fifth sectional boom, the fourth sectional boom to the sixth sectional boom are folded into an R shape and the fifth sectional boom is located above or below the fourth sectional boom when the multiple-sectional booms are in a folded state; or the multiple-sectional booms include at least six-sectional booms, a sixth sectional boom is articulated with a fifth sectional boom, the fourth sectional boom to the sixth sectional boom are folded into a Z shape when the multiple-sectional booms are in a folded state.

Optionally, the multiple-sectional booms include at least five-sectional booms, when the multiple-sectional booms are in a folded state, at least one of the fourth sectional boom to a last sectional boom includes multiple arm sections, the multiple arm sections belonging to a same sectional boom are located on a same straight line and adjacent arm sections are articulated with each other, and a fifth sectional boom is folded above or below the fourth sectional boom; or the multiple-sectional booms include at least six-sectional booms, when the multiple-sectional booms are in a folded state, at least two of the fourth sectional boom to a last sectional boom include multiple arm sections, the multiple arm sections belonging to a same sectional boom are located on a same straight line and adjacent arm sections are articulated with each other, and the fourth sectional boom to a sixth sectional boom are folded into an R shape or a Z shape.

Optionally, the multiple-sectional booms include at least four-sectional booms, the third sectional boom is a bending boom, the first sectional boom, the second sectional boom and a head end of the third sectional boom are located in a first row, a tail end of the third sectional boom to a last sectional boom are located in a second row, and the first row is different from the second row.

According to the technical solution of the present application, it has the following advantages.

Firstly, for the engineering machinery provided by the present application, since the centerline of gyration of the rotating platform is located in the middle of the vehicle body, the first sectional boom extends from the rotating platform towards the rear end of the vehicle body, construction can be carried out forward as long as the first sectional boom is unfolded, compared with the prior technology that requires a 180° rotation, the construction efficiency can be improved. Since the first sectional boom to the fourth sectional boom are folded into an R shape, the space above the vehicle body can be fully utilized, which is conducive to increasing the number of sections and flexibility of the boom device. Meanwhile, since the projection of the third sectional boom at least partially overlaps a projection of the cab on a vertical projection plane perpendicular to a length direction of the vehicle body, the second sectional boom and the third sectional boom have large space in the height direction, which can make full use of the space above the vehicle body, the cross-sections of the second sectional boom and the third sectional boom can be made very high, which helps to improve the rigidity of the boom, the cab does not need to be shorter on the premise that the overall height is limited, thus saving costs.

Secondly, for the engineering machinery provided by the present application, one end of the fourth sectional boom extends to above the cab, or the cab is located between two ends of the fourth sectional boom, this arrangement can make full use of the space above the cab, making the length of the fourth sectional boom longer or shortening the length of the engineering machinery.

Thirdly, the engineering machinery provided by the present application also includes a fifth sectional boom, the fifth sectional boom is articulated with the fourth sectional boom and is located above or below the fourth sectional boom, a hinge point of the fifth sectional boom and the fourth sectional boom is located above the cab, or a hinge point of the fifth sectional boom and the fourth sectional boom is located in the front of the cab. It can make full use of the space above the cab, making the length of the fourth sectional boom and the length of the fifth sectional boom longer, or shortening the length of the engineering machinery.

Fourthly, for the engineering machinery provided by the present application, the third sectional boom is a bending boom including a first straight arm section, a bending section and a second straight arm section, the bending section avoids the rotating platform; the first straight arm section is articulated with the second sectional boom and folded below the second sectional boom; the fourth sectional boom is articulated with the second straight arm section and folded above the second straight arm section. This arrangement can make full use of the space, and the space layout is reasonable.

Fifthly, for the engineering machinery provided by the present application, a hinge point of the second sectional boom and the third sectional boom is located between the cab and the rotating platform, or a hinge point of the second sectional boom and the third sectional boom is located above a rear of the cab. This arrangement makes the box of the second sectional boom and the box of the third sectional boom have very large space in the height direction, so that the box cross-section of the second sectional boom and the box cross-section of the third sectional boom can be made very high, which helps to improve the rigidity and torsion resistance of the second sectional boom and the third sectional boom.

Lastly, for the engineering machinery provided by the present application, the multiple-sectional booms include at least four-sectional booms, the third sectional boom is a bending boom, the first sectional boom, the second sectional boom and a head end of the third sectional boom are located in a first row, a tail end of the third sectional boom to the last sectional boom are located in a second row, and the first row is different from the second row. This arrangement allows only the two large booms (that is, the first sectional boom and the second sectional boom) and the head end of the third sectional boom to be arranged in a row of space, and the tail end of the third sectional boom and the rest of the small booms to be arranged in another row of space, making the space layout reasonable.

Additional aspects and advantages of the present application will be apparent in the description section below, or may be learned by the practice of the present application.

### BRIEF DESCRIPTION OF THE DRAWINGS

The above-mentioned and/or additional aspects and advantages of the present application will become apparent and easy to understand from the description of the embodiments in conjunction with the following accompanying drawings, wherein:

FIG. 1 is a structural schematic view of an engineering machinery provided in embodiment 1 according to the present application in one implementation.

FIG. 2 is a top view of the engineering machinery shown in FIG. 1.

FIG. 3 is a schematic view of an engineering machinery provided in embodiment 1 according to the present application in another implementation.

FIG. 4 is a schematic view of an engineering machinery provided in embodiment 1 according to the present application in another implementation.

FIG. 5 is a schematic view of an engineering machinery provided in embodiment 1 according to the present application in another implementation.

FIG. 6 is a schematic view of an engineering machinery provided in embodiment 1 according to the present application in another implementation.

FIG. 7 is a schematic view of an engineering machinery provided in embodiment 2 according to the present application.

FIG. 8 is a schematic view of an engineering machinery provided in embodiment 3 according to the present application in one implementation.

FIG. 9 is a schematic view of an engineering machinery provided in embodiment 3 according to the present application in another implementation.

FIG. 10 is a schematic view of an engineering machinery provided in embodiment 4 according to the present application in one implementation.

FIG. 11 is a schematic view of an engineering machinery provided in embodiment 4 according to the present application in another implementation.

FIG. 12 is a schematic view of an engineering machinery provided in embodiment 4 according to the present application in another implementation.

### DETAILED DESCRIPTION OF THE EMBODIMENTS

The technical solution of the present application will be clearly and completely described below in conjunction with the accompanying drawings. Obviously, the described embodiments are part of the embodiments of the present application, rather than all of the embodiments. Based on the embodiments in the present application, all other embodiments obtained by those of ordinary skill in the art without creative efforts fall within the protective scope of the present application.

In the description of the present application, it should be noted that the orientation or positional relationship indicated by the terms “center”, “upper”, “lower”, “left”, “right”, “vertical”, “horizontal”, “inner”, “outer” and so on is based on the orientation or positional relationship shown in the accompanying drawings, and is only for the convenience of describing the present application and simplifying the description, and does not indicate or imply the device or element referred to must have a specific orientation, be constructed and operate in a specific orientation, and therefore should not be construed as a limitation on the present application. Furthermore, the terms “first”, “second” and “third” are used for descriptive purposes only and should not to be construed as indicating or implying relative importance.

In the description of the present application, it should be noted that, unless otherwise clearly stated and limited, the terms “installation”, “connection” and “connection” should be understood in a broad sense, for example, it can be a fixed connection, a detachable connection, or an integral connection; it can be a mechanical connection, or it can be an electrical connection; it can be a direct connection, or it can be an indirect connection through an intermediate medium, or it can be internal connection between two components. For those of ordinary skill in the art, the specific meanings of the above terms in the present application can be understood according to the specific situation.

In addition, the technical features involved in different embodiments of the present application described below can be combined with each other as long as they do not conflict with each other.

### Embodiment 1

The embodiment provides an engineering machinery, the engineering machinery may be a pump truck, a fire truck and so on. In one embodiment, the engineering machinery includes a cab, a vehicle body located behind the cab, a rotating platform 9 provided on the vehicle body, and multiple-sectional booms articulated in sequence, wherein a centerline of gyration of the rotating platform is located in a middle of the vehicle body, a first sectional boom is articulated with the rotating platform, and the first sectional boom 1 extends from the rotating platform toward a rear end of the vehicle body, a second sectional boom is articulated with the first sectional boom and folded above the first sectional boom, the first sectional boom 1 to a fourth sectional boom 4 are folded into an R shape, a projection of a third sectional boom at least partially overlaps a projection of the cab on a vertical projection plane perpendicular to a length direction of the vehicle body. It should be noted that the front third of the vehicle body is called the front, the middle third of the vehicle body is called the middle, and the rear third of the vehicle body is called the rear.

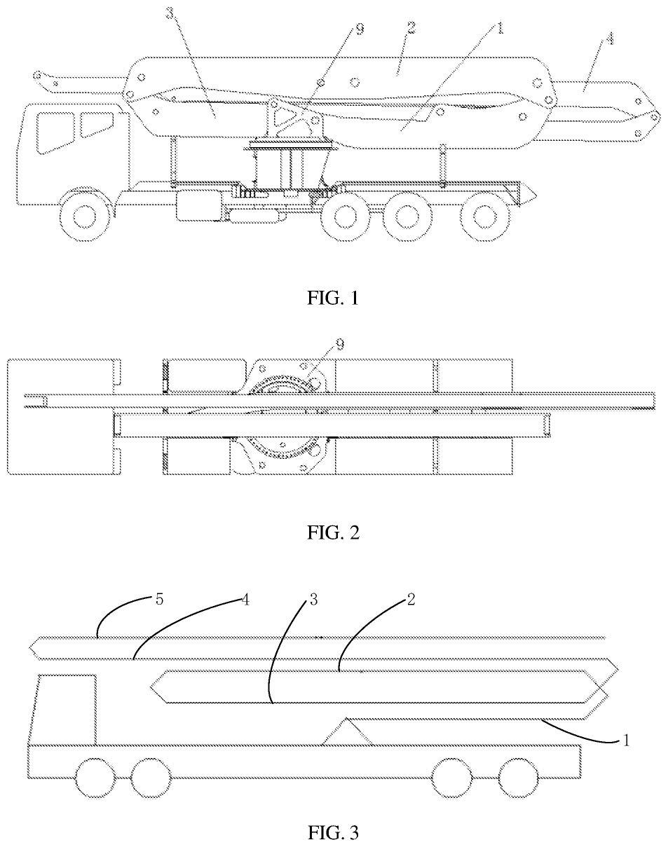

Specifically, referring to FIG. 1 to FIG. 12, the second sectional boom 2 is folded counterclockwise above the first sectional boom 1, the third sectional boom 3 is folded counterclockwise below the second sectional boom 2, and the fourth sectional boom 4 is folded counterclockwise above the third sectional boom 3.

For the engineering machinery provided by the embodiment, since the centerline of gyration of the rotating platform is located in the middle of the vehicle body, the first sectional boom extends from the rotating platform towards the rear end of the vehicle body, construction can be carried out forward as long as the first sectional boom is unfolded, compared with the prior technology that requires a 180° rotation, the construction efficiency can be improved. Since the first sectional boom to the fourth sectional boom are folded into an R shape, the space above the vehicle body can be fully utilized, which is conducive to increasing the number of sections and flexibility of the boom device. Meanwhile, since the projection of the third sectional boom at least partially overlaps a projection of the cab on a vertical projection plane perpendicular to a length direction of the vehicle body, the second sectional boom and the third sectional boom have large space in the height direction, which can make full use of the space above the vehicle body, the cross-sections of the second sectional boom and the third sectional boom can be made very high, which helps to improve the rigidity of the boom, the cab does not need to be shorter on the premise that the overall height is limited, thus saving costs.

Based on the above embodiment, in an embodiment, one end of the fourth sectional boom extends to above the cab, or the cab is located between two ends of the fourth sectional boom. In this implementation, the space above the cab can be fully utilized, making the length of the fourth sectional boom longer or shortening the length of the engineering machinery. It should be noted that the fact that the cab is located between the two ends of the fourth boom means that one end of the fourth boom extends to the front of the cab.

Based on the above embodiment, in an embodiment, the multiple-sectional booms include at least five-sectional booms, a fifth sectional boom is articulated with the fourth sectional boom and is located above or below the fourth sectional boom, a hinge point of the fifth sectional boom and the fourth sectional boom is located above the cab, or a hinge point of the fifth sectional boom and the fourth sectional boom is located in the front of the cab. It can make full use of the space above the cab, making the length of the fourth sectional boom and the length of the fifth sectional boom longer, or shortening the length of the engineering machinery.

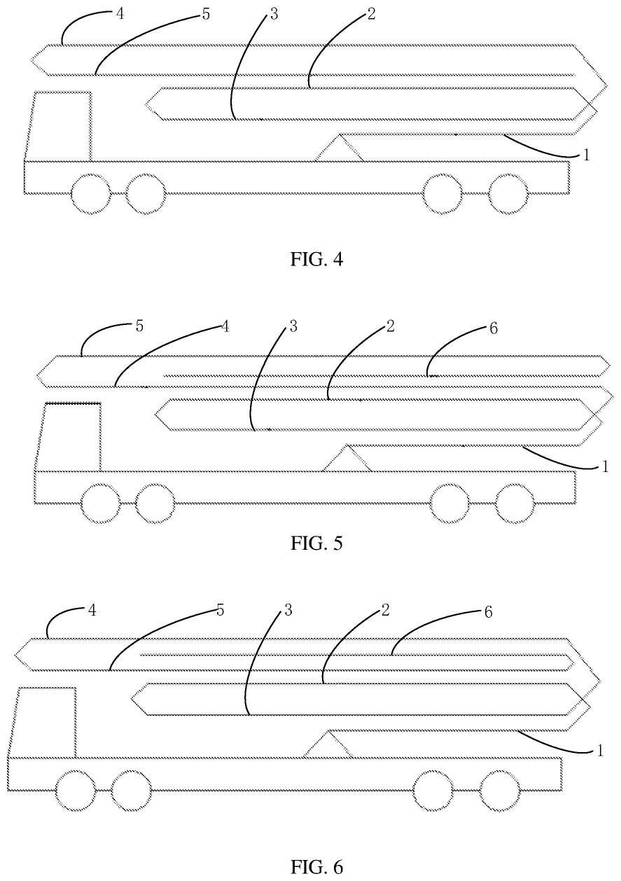

As shown in FIG. 3, the boom device includes five section booms. The fifth sectional boom 5 is folded clockwise above the fourth sectional boom 4. In an alternative embodiment, as shown in FIG. 4, the fifth sectional boom 5 is folded counterclockwise below the fourth sectional boom 4.

In an embodiment, a height of projection overlap between the third sectional boom and the cab on a vertical projection plane is greater than ½ of a height of the third sectional boom. In the embodiment, the height of the third sectional boom above the cab is small, or the entire third sectional boom is located above the vehicle body, the second sectional boom and the third sectional boom have large space in the height direction, which can make full use of the space above the vehicle body, the cross-sections of the second sectional boom and the third sectional boom can be made very high, which helps to improve the rigidity of the boom, the cab does not need to be shorter on the premise that the overall height is limited, thus saving costs.

In an embodiment, the first sectional boom is inverted. Specifically, the hinge point of the first sectional boom and the rotating platform is lower than the hinge point of the first section boom oil cylinder and the rotating platform.

In an embodiment, the third sectional boom 3 is a bending boom including a first straight arm section, a bending section and a second straight arm section, the bending section avoids the rotating platform; the first straight arm section is articulated with the second sectional boom and folded below the second sectional boom; the fourth sectional boom is articulated with the second straight arm section and folded above the second straight arm section. In the embodiment, the space below the second sectional boom can be fully utilized, the first straight arm section is arranged below the second sectional boom, making the space layout reasonable.

In an embodiment, the multiple-sectional booms include at least four-sectional booms, the third sectional boom is a bending boom, the first sectional boom, the second sectional boom and a head end of the third sectional boom are located in a first row, a tail end of the third sectional boom to a last sectional boom is located in a second row, and the first row is different from the second row. This embodiment is arranged in such a way that only the two large booms (that is, the first sectional boom and the second sectional boom) and the head end of the third sectional boom are arranged in a row of space, and the tail end of the third sectional boom and the rest of the small booms are arranged in another row of space, making the space layout reasonable.

Based on the above embodiments, in an embodiment, a hinge point of the second sectional boom 2 and the third sectional boom is located between the cab and the rotating platform 9, or a hinge point of the second sectional boom and the third sectional boom is located above a rear of the cab. When the hinge point of the second sectional boom and the third sectional boom is located above the rear of the cab, as shown in FIG. 1, the cross-section at the rear end of the second sectional boom gradually becomes smaller and the smaller cross-section is located above the rear of the cab, the larger section is located above the vehicle body, the cross section at the head end of the third sectional boom gradually becomes larger and the smaller section is located above the rear of the cab, and the larger section is located above the vehicle body. In this embodiment, since the hinge point of the second sectional boom 2 and the third sectional boom 3 is located between the cab and the rotating platform 9 or above the rear of the cab, the box of the second sectional boom 2 and the box of the third sectional boom 3 have very large space in the height direction, so that the box cross-section of the second sectional boom 2 and the box cross-section of the third sectional boom 3 can be made very high, which helps to improve the rigidity and torsion resistance of the second sectional boom 2 and the third sectional boom 3.

Based on the above embodiments, in an embodiment, the multiple-sectional booms include at least six-sectional booms, a sixth sectional boom 6 is articulated with a fifth sectional boom 5, the fourth sectional boom 4 to the sixth sectional boom 6 are folded into an R shape and the fifth sectional boom is located above or below the fourth sectional boom when the multiple-sectional booms are in a folded state. As shown in FIG. 5, the boom device includes six-sectional booms, the second sectional boom 2 is folded counterclockwise above the first sectional boom 1, the third sectional boom 3 is folded counterclockwise below the second sectional boom 2, the fourth sectional boom 4 is folded counterclockwise above the third sectional boom 3, the fifth sectional boom 5 is folded clockwise above the fourth sectional boom 4, and the sixth sectional boom 6 is folded clockwise below the fifth sectional boom 5. In an alternative embodiment, as shown in FIG. 6, the multiple-sectional booms include six-sectional booms, the second sectional boom 2 is folded counterclockwise above the first sectional boom 1, the third sectional boom 3 is folded counterclockwise below the second sectional boom 2, the fourth sectional boom 4 is folded counterclockwise above the third sectional boom 3, the fifth sectional boom 5 is folded counterclockwise below the fourth sectional boom 4, and the sixth sectional boom 6 is folded counterclockwise above the fifth sectional boom 5. In other alternative embodiments, the multiple-sectional booms device may include seven sections, the fourth sectional boom 4 to the sixth sectional boom 6 are folded into an R shape when the multiple-sectional booms are in a folded state.

### Embodiment 2

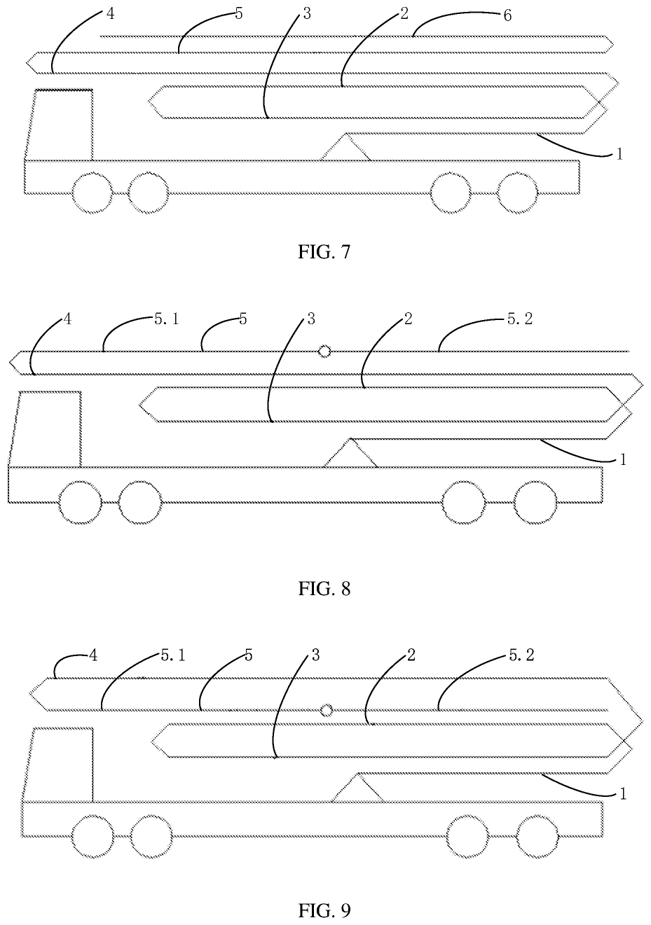

The difference between this embodiment and the above embodiment is that the multiple-sectional booms include at least six-sectional booms, a sixth sectional boom is articulated with a fifth sectional boom, the fourth sectional boom 4 to the sixth sectional boom 6 are folded into a Z shape when the multiple-sectional booms are in a folded state. In one embodiment, as shown in FIG. 7, the multiple-sectional booms include six-sectional booms, the second sectional boom 2 is folded counterclockwise above the first sectional boom 1, the third sectional boom 3 is folded counterclockwise below the second sectional boom 2, the fourth sectional boom 4 is folded counterclockwise above the third sectional boom 3, the fifth sectional boom 5 is folded clockwise above the fourth sectional boom 4, and the sixth sectional boom 6 is folded counterclockwise above the fifth sectional boom 5. In other alternative embodiments, the boom device may include seven sections, the fourth sectional boom 4 to the sixth sectional boom 6 are folded into a Z shape in the folded state of the boom device.

### Embodiment 3

The difference between this embodiment and embodiment 1 is that the multiple-sectional booms include at least five-sectional booms, when the multiple-sectional booms are in a folded state, at least one of the fourth sectional boom to a last sectional boom includes multiple arm sections, the multiple arm sections belonging to a same sectional boom are located on a same straight line and adjacent arm sections are articulated with each other, and a fifth sectional boom is folded above or below the fourth sectional boom. In one embodiment, the multiple-sectional booms include five-sectional booms, the fifth sectional boom includes two arm sections, and the two arm sections are a first arm section 5.1 and a second arm section 5.2 respectively. When the multiple-sectional booms are in the folded state, the first sectional boom 5.1 and the second sectional boom 5.2 are located on the same straight line, and the first sectional boom 5.1 are articulated with the second sectional boom 5.2. As shown in FIG. 8, the second sectional boom 2 is folded counterclockwise above the first sectional boom 1, the third sectional boom 3 is folded counterclockwise below the second sectional boom 2, the fourth sectional boom 4 is folded counterclockwise above the third sectional boom 3, the fifth sectional boom 5 is folded clockwise above the fourth sectional boom 4, and the two arm sections of the fifth sectional boom 5 are located on the same straight line.

In an alternative embodiment, as shown in FIG. 9, the second sectional boom 2 is folded counterclockwise above the first sectional boom 1, the third sectional boom 3 is folded counterclockwise below the second sectional boom 2, the fourth sectional boom 4 is folded counterclockwise above the third sectional boom 3, the fifth sectional boom 5 is folded counterclockwise below the fourth sectional boom 4, and the two arm sections of the fifth sectional boom 5 are located on the same straight line.

In other alternative embodiments, the multiple-sectional booms include five-sectional booms, the fourth sectional boom 4 can include at least a plurality of arm sections, the plurality of arm sections belonging to the fourth sectional boom are located on the same straight line and adjacent arm sections are articulated with each other.

### Embodiment 4

The difference between this embodiment and embodiment 1 is that the multiple-sectional booms include at least six-sectional booms, when the multiple-sectional booms are in a folded state, at least two of the fourth sectional boom to a last sectional boom include multiple arm sections, the multiple arm sections belonging to a same sectional boom are located on a same straight line and adjacent arm sections are articulated with each other, and the fourth sectional boom to a sixth sectional boom are folded into an R shape or a Z shape.

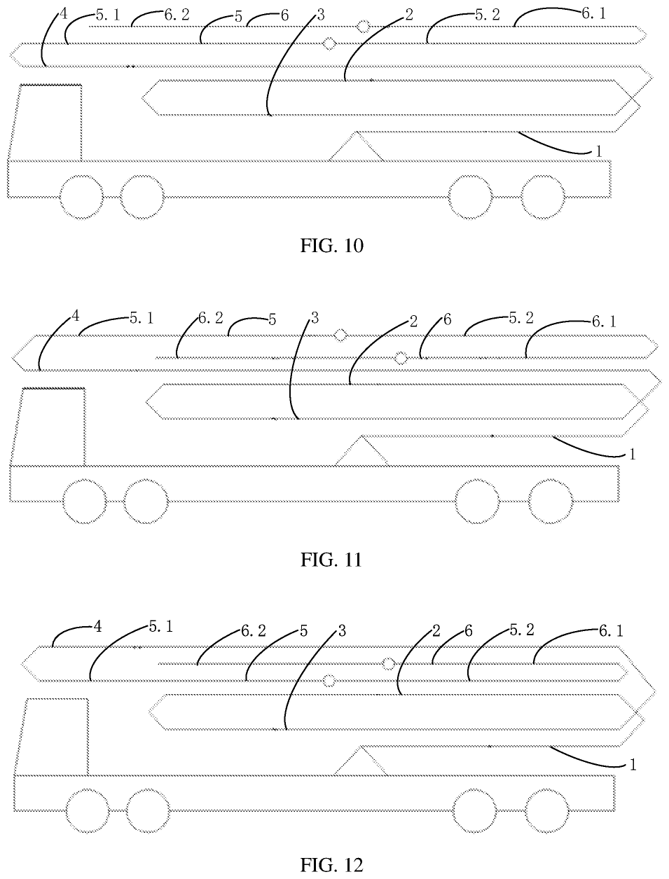

In one embodiment, as shown in FIG. 10, the second sectional boom 2 is folded counterclockwise above the first sectional boom 1, the third sectional boom 3 is folded counterclockwise below the second sectional boom 2, the fourth sectional boom 4 is folded counterclockwise above the third sectional boom 3, the fifth sectional boom 5 is folded clockwise above the fourth sectional boom 4, and the sixth sectional boom 6 is folded counterclockwise above the fifth sectional boom 5. Wherein the fifth sectional boom 5 includes two arm sections which are the first arm section 5.1 and the second arm section 5.2 respectively, and the sixth sectional boom 6 includes two arm sections which are the third arm section 6.1 and the fourth arm section 6.2 respectively. The first arm section 5.1 is articulated with the fourth sectional boom 4, the second arm section 5.2 and the first arm section 5.1 are articulated with each other and located on the same straight line, the third arm section 6.1 is articulated with the second arm section 5.2, the fourth arm section 6.2 and the third arm section 6.1 are articulated with each other and located on the same straight line, and the fourth arm section 6.2 and the third arm section 6.1 are located above the second arm section 5.2 and the first arm section 5.1.

In one embodiment, as shown in FIG. 11, the second sectional boom 2 is folded counterclockwise above the first sectional boom 1, the third sectional boom 3 is folded counterclockwise below the second sectional boom 2, the fourth sectional boom 4 is folded counterclockwise above the third sectional boom 3, the fifth sectional boom 5 is folded clockwise above the fourth sectional boom 4, and the sixth sectional boom 6 is folded clockwise below the fifth sectional boom 5. Wherein the fifth sectional boom 5 includes two arm sections which respectively are the first arm section 5.1 and the second arm section 5.2, and the sixth sectional boom 6 includes two arm sections which respectively are the third arm section 6.1 and the fourth arm section 6.2. The first arm section 5.1 is articulated with the fourth sectional boom 4, the second arm section 5.2 and the first arm section 5.1 are articulated with each other and located on the same straight line, the third arm section 6.1 is articulated with the second arm section 5.2, the fourth arm section 6.2 and the third arm section 6.1 are articulated with each other and located on the same straight line, and the fourth arm section 6.2 and the third arm section 6.1 are located below the second arm section 5.2 and the first arm section 5.1.

In one embodiment, as shown in FIG. 12, the second sectional boom 2 is folded counterclockwise above the first sectional boom 1, the third sectional boom 3 is folded counterclockwise below the second sectional boom 2, the fourth sectional boom 4 is folded counterclockwise above the third sectional boom 3, the fifth sectional boom 5 is folded counterclockwise below the fourth sectional boom 4, and the sixth sectional boom 6 is folded counterclockwise above the fifth sectional boom 5. Wherein the fifth sectional boom 5 includes two arm sections which respectively are the first arm section 5.1 and the second arm section 5.2, and the sixth sectional boom 6 includes two arm sections which respectively are the third arm section 6.1 and the fourth arm section 6.2. The first arm section 5.1 is articulated with the fourth sectional boom 4, the second arm section 5.2 and the first arm section 5.1 are articulated with each other and located on the same straight line, the third arm section 6.1 is articulated with the second arm section 5.2, the fourth arm section 6.2 and the third arm section 6.1 are articulated with each other and located on the same straight line, and the fourth arm section 6.2 and the third arm section 6.1 are located above the second arm section 5.2 and the first arm section 5.1.

Obviously, the above-mentioned embodiments are only examples for clear explanation and are not intended to limit the implementation. For those of ordinary skill in the art, other different forms of changes or modifications can be made based on the above description. An exhaustive list of all implementations is neither necessary nor possible herein. The obvious changes or modifications derived therefrom are still within the protection scope of the present application.

What is claimed is:

1. An engineering machinery, comprising:
a cab;
a vehicle body located behind the cab;
a rotating platform provided on the vehicle body; and
multiple-sectional booms articulated in sequence;
wherein a centerline of gyration of the rotating platform is located in a middle of the vehicle body, a first sectional boom is articulated with the rotating platform, and the first sectional boom extends from the rotating platform toward a rear end of the vehicle body, a second sectional boom is articulated with the first sectional boom and folded above the first sectional boom, the first sectional boom to a fourth sectional boom are folded into an R shape, a projection of a third sectional boom at least partially overlaps a projection of the cab on a vertical projection plane perpendicular to a length direction of the vehicle body.

2. The engineering machinery according to claim 1, wherein one end of the fourth sectional boom extends to above the cab, or the cab is located between two ends of the fourth sectional boom.

3. The engineering machinery according to claim 1, wherein the multiple-sectional booms comprise at least five-sectional booms, a fifth sectional boom is articulated with the fourth sectional boom and is located above or below the fourth sectional boom, a hinge point of the fifth sectional boom and the fourth sectional boom is located above the cab, or a hinge point of the fifth sectional boom and the fourth sectional boom is located in the front of the cab.

4. The engineering machinery according to claim 1, wherein a height of projection overlap between the third sectional boom and the cab on a vertical projection plane is greater than ½ of a height of the third sectional boom.

5. The engineering machinery according to claim 1, wherein the first sectional boom is inverted.

6. The engineering machinery according to claim 1, wherein the third sectional boom is a bending boom comprising a first straight arm section, a bending section and a second straight arm section, the bending section avoids the rotating platform; the first straight arm section is articulated with the second sectional boom and folded below the second sectional boom; the fourth sectional boom is articulated with the second straight arm section and folded above the second straight arm section.

7. The engineering machinery according to claim 1, wherein a hinge point of the second sectional boom and the third sectional boom is located between the cab and the rotating platform, or a hinge point of the second sectional boom and the third sectional boom is located above a rear of the cab.

8. The engineering machinery according to claim 1, wherein the multiple-sectional booms comprise at least six-sectional booms, a sixth sectional boom is articulated with a fifth sectional boom, the fourth sectional boom to the sixth sectional boom are folded into an R shape and the fifth sectional boom is located above or below the fourth sectional boom when the multiple-sectional booms are in a folded state.

9. The engineering machinery according to claim 1, wherein the multiple-sectional booms comprise at least six-sectional booms, a sixth sectional boom is articulated with a fifth sectional boom, the fourth sectional boom to the sixth sectional boom are folded into a Z shape when the multiple-sectional booms are in a folded state.

10. The engineering machinery according to claim 1, wherein the multiple-sectional booms comprise at least five-sectional booms, when the multiple-sectional booms are in a folded state, at least one of the fourth sectional boom to a last sectional boom comprises multiple arm sections, the multiple arm sections belonging to a same sectional boom are located on a same straight line and adjacent arm sections are articulated with each other, and a fifth sectional boom is folded above or below the fourth sectional boom.

11. The engineering machinery according to claim 1, wherein the multiple-sectional booms comprise at least six-sectional booms, when the multiple-sectional booms are in a folded state, at least two of the fourth sectional boom to a last sectional boom comprise multiple arm sections, the multiple arm sections belonging to a same sectional boom are located on a same straight line and adjacent arm sections are articulated with each other, and the fourth sectional boom to a sixth sectional boom are folded into an R shape or a Z shape.

12. The engineering machinery according to claim 1, wherein the multiple-sectional booms comprise at least four-sectional booms, the third sectional boom is a bending boom, the first sectional boom, the second sectional boom and a head end of the third sectional boom are located in a first row, a tail end of the third sectional boom to a last sectional boom are located in a second row, and the first row is different from the second row.
